(19) United States
(12) Patent Application Publication
(10) Pub. No.: US 2016/0185641 A1
(43) Pub. Date: Jun. 30, 2016

(54) MOBILE THERMAL TREATMENT METHOD FOR PROCESSING ORGANIC MATERIAL

(71) Applicant: SGC ADVISORS, LLC, Atlanta, GA (US)

(72) Inventor: Joseph E. Zuback, Camarillo, CA (US)

(21) Appl. No.: 14/908,842

(22) PCT Filed: Jul. 31, 2014
(86) PCT No.: PCT/US14/49012

§ 371 Date: Jan. 29, 2016

Related U.S. Application Data
(60) Provisional application No. 61/860,461, filed on Jul. 31, 2013.

(51) Int. Cl. C02F 11/18; C02F 11/14; C02F 11/12; C02F 11/02; C02F 11/04

(52) U.S. Cl. CPC C02F 11/185; C02F 11/18; C02F 11/02; C02F 11/04; C02F 11/12; C02F 11/14; C02F 2101/30

(57) ABSTRACT

An integrated mobile thermal treatment system and method is disclosed for processing organic material. In a first mode of operation, the system includes all process components necessary to thermally treat organic material to achieve cell lysing and cell formation integrated in a common skid-assembled unit. In a second mode of operation, the system additionally includes pre-slurrying, pressurization, selective solids separation, and/or post-dewatering process components to minimize feed volume by pre-slurrying, deliver feed at the necessary treatment pressure, thermally treat organic material to achieve cell lysing and cell formation integrated in a separate or common skid-assembled unit, and produce a dewatered sludge cake suitable for disposal or use as a fertilizer of fuel.

### CROSS REFERENCE TO RELATED APPLICATION

This application claims priority to U.S. Provisional Patent Application Ser. No. 61/860,461, filed Jul. 31, 2013, the disclosure of which is hereby expressly incorporated by reference herein in its entirety.

### FIELD OF THE DISCLOSURE

The present disclosure relates to processing of organic material. More particularly, the present disclosure relates to a thermal treatment system and method for processing organic material.

### BACKGROUND OF THE DISCLOSURE

Organic material, such as sludge from sewage and wastewater treatment plants (WWTP), represents a serious disposal problem. This sludge generally contains a mixture of solids, commonly referred to as biosolids, and varying amounts of free water.

The large volume of cell-bound water in biosolids makes the disposal of sewage sludge containing biosolids challenging. In particular, the cost of incinerating sewage sludge is prohibitive because the cell-bound water gives biosolids a net negative lower heating value. Similarly, if sewage sludge is thermally dewatered, the process may have a net negative energy balance due to the energy required to evaporate water from the sewage sludge. Also, the cost of transporting sewage sludge is significant because the cell-bound water impacts the weight of the sludge. Usually the WWTP must pay a “tipping fee” to have another party dispose of its biosolids. Sludge containing biosolids is presently landfilled, land-applied, or dried and used as a fertilizer. However, these disposal methods may have negative environmental effects, such as the generation of undesirable odors and the contamination of soil or groundwater by living disease-causing organisms, toxic heavy metals, and/or other chemical or pharmaceutical compounds contained in the biosolids. Between approximately 7.1 and 7.6 million dry (short) tons of biosolids are produced each year in the U.S. alone, with a similar amount produced in Europe, and Asia. Thus, an adequate disposal method is important.

In addition to the current need for an adequate method of disposing of biosolids, there is growing public support for increased utilization of renewable, or “green”, energy sources. Well-known forms of renewable energy include solar energy, wind energy, and geothermal energy, but these sources lack an adequate supply. Biomass materials, such as mill residues, agricultural crops and wastes, and industrial wastes, have long been used as renewable fuels. Biosolids, on the other hand, have not previously been considered as a renewable energy source due to the large volume of cell-bound water contained therein. As discussed above, the large volume of cell-bound water in biosolids significantly impacts both the cost of incinerating biosolids and the cost of transporting biosolids.

Accordingly, new systems and methods for processing and disposing of organic material are needed.

### SUMMARY

The present disclosure provides a thermal treatment system and method for processing organic material. In the primary mode of operation, the system treats undigested material to break down organic material to enhance digestion or post-treats digested material to generate a renewable fuel product.

In addition, to address the various sizes of wastewater treatment plants, among other issues, some great economies can be achieved through mounting a new system and method for processing and disposing of organic material upon a skid whereby it can be transported between various facilities.

According to an exemplary embodiment of the present disclosure, a mobile thermal treatment system is provided for processing a feedstock including organic material and water. The system includes a mobile support structure, a slurrying device that produces a slurry from the feedstock, the slurry having a solids content of about 16% solids or less, a pump that pressurizes the slurry to a pressure above the saturation pressure of water at a subsequent elevated temperature, a thermal input device coupled to the mobile support structure, the thermal input device heating the pressurized slurry to the elevated temperature sufficient for cell lysing and char formation, and a reaction device coupled to the mobile support structure, the reaction device providing a retention time to thermally treat the heated slurry at the elevated temperature.

According to an exemplary embodiment of the present disclosure, a mobile thermal treatment system is provided for processing a feedstock including organic material and water. The system includes a mobile support structure, a slurrying device that produces a slurry from the feedstock, a first pump that pressurizes the slurry to a first pressure above the saturation pressure of water at a first elevated temperature, a first thermal input device coupled to the mobile support structure downstream of the first pump, the first thermal input device heating the pressurized slurry to the first elevated temperature, a second pump coupled to the mobile structure downstream of the first thermal input device, the second pump further pressurizing the heated slurry to a second pressure above the saturation pressure of water at a second elevated temperature, a second thermal input device coupled to the mobile support structure downstream of the second pump, the second thermal input device further heating the pressurized slurry to the second elevated temperature sufficient for cell lysing and char formation, and a reaction device coupled to the mobile support structure, the reaction device providing a retention time to thermally treat the heated slurry at the second elevated temperature.

According to yet another exemplary embodiment of the present disclosure, a thermal treatment system is provided for processing an organic material. The system includes a digester that digests the organic material, the digester having an input and an output, and a thermal input device that heats the organic material, the thermal input device selectively communicating with the input to the digester to break down undigested material prior to digestion or the output of the digester to heat digested material from the digester.

According to still yet another exemplary embodiment of the present disclosure, a method is provided for processing an organic material. The method includes the steps of producing a desired concentration of solids in organic material either before digestion or from a digester to a concentration range of as little as 0.5%, 1%, 2%, 5% or as high as 12%, 20%, 25%, 60%, or may be within any range defined between any pair of the foregoing values with an optional slurrying, pumping digested material at the desired concentration with a pump suitable for pumping undigested or digested material with viscosity characteristic typical of a solids concentration in the range of as little as 0.5%, 1%, 2%, 5% or as high as 12%, 20%, 25%, 60%, or may be within any range defined between any pair of the foregoing values to a temperature range of as low as 50, 100, 200 or as high as 500, 600 or 750 degrees Fahrenheit, or may be within any range defined between any pair of the foregoing values, continuously through a heat exchanger to preheat the material, further heating the material via injection of steam in the pipeline between the heat exchanger and a reactor, maintaining the material at a temperature range of as low as 50, 100, 200 or as high as 500, 600 or 750 degrees Fahrenheit, or may be within any range defined between any pair of the foregoing values, in a continuous flow pipe reactor for a retention time in the reactor of as little as 30 seconds, 5 minutes or 15 minutes or as high as 20, 60 or 2,880 minutes, or may be within any range defined between any pair of the foregoing values, flowing the heated material through the heat exchanger to exchange heat with unheated material, reducing the temperature and pressure of the heated material following the heat exchanger by flowing through a pressure control valve, optionally flowing through a secondary vessel under reduced temperature and pressure conditions under temperature and time conditions necessary to comply with criteria for thermal inactivation of pathogens necessary for U.S. EPA Class A regulations, and optionally further reducing the temperature of heated digested material with a secondary heat exchanger with water used as a cooling medium.

According to still yet another exemplary embodiment of the present disclosure, an integrated mobile system is provided for processing an organic material at a rate of as low as 0.5, 1, 5, 10 or as up to 50, 100, 500, 1000 dry tons, or may be within any range defined between any pair of the foregoing values, of digested sludge per day present as a slurry with concentrations of solids ranging from as little as 0.5%, 1%, 2%, 5% or as high as 12%, 20%, 25%, 60%, or may be within any range defined between any pair of the foregoing values, by weight, including at least one of a high pressure feed pump, pipe-in-pipe or spiral heat exchanger, continuous flow reactor, pressure control valve, auxiliary holding tank for holding sludge at a temperature greater than or equal to the elevated temperature for additional time necessary to comply with pathogen inactivation regulations, interconnecting piping, analytical devices to measure temperature and pressure, and structural elements necessary for safe transportation and installation of the mobile system.

According to still yet another exemplary embodiment of the present disclosure, a system is provided for processing combined primary and secondary treatment sludge and aerobically or anaerobically digested sludge from a wastewater treatment plant at a rate of as low as 0.5, 1, 5, 10 or as up to 50, 100, 500, 1000 dry tons, or may be within any range defined between any pair of the foregoing values, of combined sludge per day present as a slurry either as individual sludge types or as a blend of sludge types with concentrations of solids ranging from as little as 0.5%, 1%, 2%, 5% or as high as 12%, 20%, 25%, 60%, or may be within any range defined between any pair of the foregoing values, by weight, including at least one of a sludge slurrying process to increase the solids concentration to as little as 0.5%, 1%, 2%, 5% or as high as 12%, 20%, 25%, 60%, or may be within any range defined between any pair of the foregoing values, by weight, a high pressure feed pump, heat exchanger, flow reactor, pressure control valve, interconnecting piping, analytical devices to measure temperature and pressure, a sludge dewatering process to remove as low as 5% to 99.9%, or any concentration between the foregoing range, of slurry solids exiting the reactor and retain said solids in the form of a semi-solid sludge cake containing solids ranging from up to 5%, 15%, 25% to 65%, 75%, 90%, or may be within any range defined between any pair of the foregoing values, by weight, and to produce a filtered water stream, such as but not limited to centrate from a centrifuge dewatering device, and an aerobic or anaerobic biological process to remove residual dissolved organic compounds within the filtered water stream via either biological oxidation or biological conversion to methane suitable for production of energy via combustion.

According to still yet another exemplary embodiment of the present disclosure, a system is provided for processing combined primary and secondary treatment sludge and aerobically or anaerobically digested sludge from a wastewater treatment plant at a rate of as low as 0.5, 1, 5, 10 or as up to 50, 100, 500, 1000 dry tons, or may be within any range defined between any pair of the foregoing values, of combined sludge per day present as a slurry either as individual sludge types or as a blend of sludge types with concentrations of solids ranging from as little as 0.5%, 1%, 2%, 5% or as high as 12%, 20%, 25%, 60%, or may be within any range defined between any pair of the foregoing values, by weight, including at least one of a sludge slurrying process to increase the solids concentration to as little as 0.5%, 1%, 2%, 5% or as high as 12%, 20%, 25%, 60%, or may be within any range defined between any pair of the foregoing values, by weight, a high pressure feed pump, heat exchanger, flow reactor, pressure control valve, interconnecting piping, analytical devices to measure temperature and pressure, a suspended solids classifier that separates inert or non-reactive solids such as grit and sand from reactive solids capable of further decomposition via biological action or thermal reaction such as carbon, char and other organic carbonaceous particles via hydraulic classification by gravity or centrifugal forces or screens that achieve separation by utilizing differences in particle density and size via separation processes such as but not limited to hydrocyclones, vortexing grit removal, sieves, and screens, an aerobic or anaerobic treatment process that further decomposes organic materials present either as dissolved carbonaceous compounds or reactive solids capable of further decomposition via biological action, and a thermal process that receives waste sludge from said aerobic or anaerobic treatment process that further decomposes organic materials and further degrades said organic materials, with the thermal process either a separate thermal process dedicated to this purpose or the thermal process described herein that treats a blend of sludge types with concentrations of solids ranging from as little as 0.5%, 1%, 2%, 5% or as high as 12%, 20%, 25%, 60%, or may be within any range defined between any pair of the foregoing values, by weight, and a sludge separation and concentration process to remove 5% to 99.9%, or any concentration between the foregoing range, of inert solids exiting the suspended solids classifier and retain said solids in the form of a slurry or semi-solid sludge cake containing solids ranging from 2% to 85% by weight.

According to still yet another exemplary embodiment of the present disclosure, a system is provided for processing combined primary and secondary treatment sludge from a wastewater treatment plant at a rate of as low as 0.5, 1, 5, 10 or as up to 50, 100, 500, 1000 dry tons, or may be within any range defined between any pair of the foregoing values, of combined primary and secondary treatment sludge per day present as a slurry either alone or blended with organic material from a digester with concentrations of solids ranging from as little as 0.5%, 1%, 2%, 5% or as high as 12%, 20%, 25%, 60%, or may be within any range defined between any pair of the foregoing values, by weight, including at least one of a sludge slurrying process to increase the solids concentration as little as 0.5%, 1%, 2%, 5% or as high as 12%, 20%, 25%, 60%, or may be within any range defined between any pair of foregoing values, by weight, a high pressure feed pump, heat exchanger, flow reactor, pressure control valve, interconnecting piping, analytical devices to measure temperature and pressure, introduction of treatment plant effluent or other sources of clean water with low dissolved organic content prior to dewatering the biosolids to remove dissolved organics from the solids prior to sludge dewatering such that the dewatered sludge complies with Vector Attraction Reduction criteria for thermally treated municipal sludge necessary to produce Class A sludge (per U.S. EPA) and/or to cool the slurry to less than 150 F in order to reduce potential for polymer degradation, sludge dewatering process to remove 5% to 99.9%, or any concentration between the foregoing range, of slurry solids exiting the reactor and retain said solids in the form of a semi-solid sludge cake containing solids ranging from 2% to 85% by weight.

According to still yet another exemplary embodiment of the present disclosure, a system is provided for processing for processing combined primary and secondary treatment sludge and aerobically or anaerobically digested sludge from a wastewater treatment plant at a rate of as low as 0.5, 1, 5, 10 or as up to 50, 100, 500, 1000 dry tons, or may be within any range defined between any pair of the foregoing values, of individual or combined sludge per day present as a slurry either alone or blended with organic material from a digester with concentrations of solids ranging from as little as 0.5%, 1%, 2%, 5% or as high as 12%, 20%, 25%, 60%, or may be within any range defined between any pair of the foregoing values, by weight, including at least one of a sludge slurrying process to increase the solids concentration to as little as 0.5%, 1%, 2%, 5% or as high as 12%, 20%, 25%, 60%, or may be within any range defined between any pair of the foregoing values, by weight, a high pressure feed pump, heat exchanger, flow reactor, pressure control valve, interconnecting piping, analytical devices to measure temperature and pressure, addition of ammonia, phosphate, and magnesium ions to precipitate struvite crystals in the slurry such that the presence of struvite crystals in the resultant dewatered sludge increases the nitrogen and phosphorous content of the dewatered sludge and the subsequent fertilizer value of the sludge and also reduces the concentration of ammonia and phosphorous in residual water pressed from the dewatered sludge and thus reduces the costs to remove nitrogen and phosphorous from the residual water within the municipal wastewater treatment plant, sludge dewatering process to remove 5% to 99.9%, or any concentration between the foregoing range, of slurry solids exiting the reactor and retain said solids in the form of a semi-solid sludge cake containing solids ranging from 2% to 85% by weight.

According to still yet another exemplary embodiment of the present disclosure, a system is provided for processing for processing combined primary and secondary treatment sludge and aerobically or anaerobically digested sludge from a wastewater treatment plant at a rate of as low as 0.5, 1, 5, 10 or as up to 50, 100, 500, 1000 dry tons, or may be within any range defined between any pair of the foregoing values, of individual or combined sludge per day present as a slurry either alone or blended with organic material from a digester with concentrations of solids ranging from as little as 0.5%, 1%, 2%, 5% or as high as 12%, 20%, 25%, 60%, or may be within any range defined between any pair of the foregoing values, by weight, including at least one of a sludge slurrying process to increase the solids concentration up to 0.5 to 25% or greater by weight, a high pressure feed pump, heat exchanger, flow reactor, pressure control valve, interconnecting piping, analytical devices to measure temperature and pressure, an anaerobic digestion process to treat a portion of the thermally treated slurry to reduce the concentration of dissolved organics in the total sludge when the waste sludge from said anaerobic digestion is blended with the remainder of the thermally treated waste activated sludge and dewatered, a sludge dewatering process to remove 5% to 99.9%, or any concentration between the foregoing range, of the combined thermally treated slurry solids including the portion diverted to an anaerobic digester the portion not diverted to an anaerobic digester and retain said solids in the form of a semi-solid sludge cake containing solids ranging from 2% to 85% by weight that complies with U.S. EPA Class A sludge and Vector Attraction Reduction criteria.

According to still yet another exemplary embodiment of the present disclosure, the aforementioned systems described above, can be mounted on a mobile support structure, such as a skid. This skid would be designed to accommodate at least one of a trailer, truck, train, or other mode of transportation. The skid would allow for the easy transportation of the system to where it will be placed in service. In addition, the skid allows the system to potentially service more than one wastewater treatment plant whereby great economies can be realized.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic diagram of an integrated mobile system operating in a mode to treat organic material such as digested sludge pre-pumped to adequately high pressure and temperature and temperature for the process to generate a semi-solids sludge cake suitable for disposal or use as fertilizer or a renewable fuel product with downstream sludge dewatering equipment separate from the integrated mobile system;

FIG. 2 is a schematic diagram of an integrated mobile system operating in a mode to treat organic material such as pre-slurried digested sludge pre-pumped to adequately high pressure and temperature required for the process to generate a semi-solids sludge cake suitable for disposal or use as fertilizer or a renewable fuel product with downstream sludge dewatering equipment separate from the integrated mobile system;

FIG. 3 is a schematic diagram of a an integrated mobile system operating in a mode to treat organic material such as digested sludge with the skid assembled system including a slurrying process to pre-slurry digester sludge, a pump to adequately produce high pressure and a thermal process to adequately achieve a temperature required for the process to generate a semi-solids sludge cake suitable for disposal or use as fertilizer or a renewable fuel product, and treated sludge dewatering equipment included within the integrated mobile system;

FIG. 4 is a schematic diagram of an integrated mobile system operating in a mode to treat organic material such as digested sludge and a pump to adequately produce high pressure and a thermal process to adequately achieve a temperature required for the process to generate a semi-solids sludge cake suitable for disposal or use as fertilizer or a renewable fuel product with treated sludge dewatering equipment separate from the integrated mobile system;

FIG. 5 is a schematic diagram of a system operating in a mode to treat organic material such as slurried undigested sludge, a pump to adequately produce high pressure and a thermal process to adequately achieve a temperature required for the process to generate a semi-solids sludge cake suitable for disposal or use as fertilizer or a renewable fuel product with downstream sludge dewatering equipment;

FIG. 6 is a schematic diagram of a system operating in a mode to treat organic material such as slurried undigested sludge, a pump to adequately produce high pressure and a thermal process to adequately achieve a temperature required to generate a semi-solids sludge cake suitable for disposal or use as fertilizer or a renewable fuel product with downstream sludge dewatering equipment that produces water removed from the sludge that is acceptable for treatment of said water via an aerobic or anaerobic treatment process for removal of dissolved carbonaceous constituents from said water and conversion of said constituents into additional biomass and carbon-based gaseous products such as methane and carbon monoxide;

FIG. 7 is a schematic diagram of a system operating in a mode to treat organic material such as slurried undigested, a pump to adequately produce high pressure and a thermal process to adequately achieve a temperature required to generate a semi-solids sludge cake suitable for disposal or use as fertilizer or a renewable fuel product with downstream sludge dewatering equipment, and the addition prior to dewatering the slurry of water to reduce the residual dissolved organic content in the final dewatered sludge cake necessary to comply with U.S. EPA Vector Attraction Reduction requirements;

FIG. 8 is a schematic diagram of a system operating in a mode to treat organic material such as slurried undigested, a pump to adequately produce high pressure and a thermal process to adequately achieve a temperature required to generate a semi-solids sludge cake suitable for disposal or use as fertilizer or a renewable fuel product with downstream sludge dewatering equipment, and the addition prior to dewatering the slurry of chemicals to capture ammonia and phosphate to enhance the fertilizer value via precipitation of struvite that is subsequently retained in the final dewatered sludge cake;

FIG. 9 is a schematic diagram of a system operating in a mode to treat organic material such as slurried undigested sludge, a pump to adequately produce high pressure and a thermal process to adequately achieve a temperature required to generate a semi-solids sludge cake suitable for disposal or use as fertilizer or a renewable fuel product with downstream sludge dewatering equipment that produces water removed from the sludge that is acceptable for treatment of said water via an aerobic or anaerobic treatment process for removal of dissolved carbonaceous constituents from said water and conversion of said constituents into carbon-based gaseous products such as methane and carbon monoxide and additional biomass that when the excess biomass is recycled to the feed of the thermal process the residual dissolved organic content in the final dewatered sludge cake is reduced as necessary for the total treatment process to comply with U.S. EPA Vector Attraction Reduction requirements;

FIG. 10 is a schematic diagram of a system operating in a mode to treat organic material such as slurried digested and/or undigested sludge pre-pumped to adequately high pressure required for the process to generate a semi-solids sludge cake suitable for disposal or use as fertilizer with downstream suspended solids classification via gravity or centrifugal force separation to separate inert material like grit and sand from largely carbonaceous reactive material like carbon, char, and other carbonaceous suspended solids that remain in the liquid stream, an existing aerobic wastewater treatment plant or separate aerobic or anaerobic treatment process as shown in FIG. 9 for removal of dissolved carbonaceous constituents from the liquid stream and conversion of said constituents into carbon-based gaseous products such as methane and carbon monoxide and additional biomass that is becomes of the organic material fed to the thermal treatment process; and

FIG. 11A is a perspective view of an exemplary thermal treatment system integrated on a skid;

FIG. 11B is a top plan view of the thermal treatment system of FIG. 11A; and

FIG. 11C is an end elevational view of the thermal treatment system of FIG. 11A.

### DETAILED DESCRIPTION

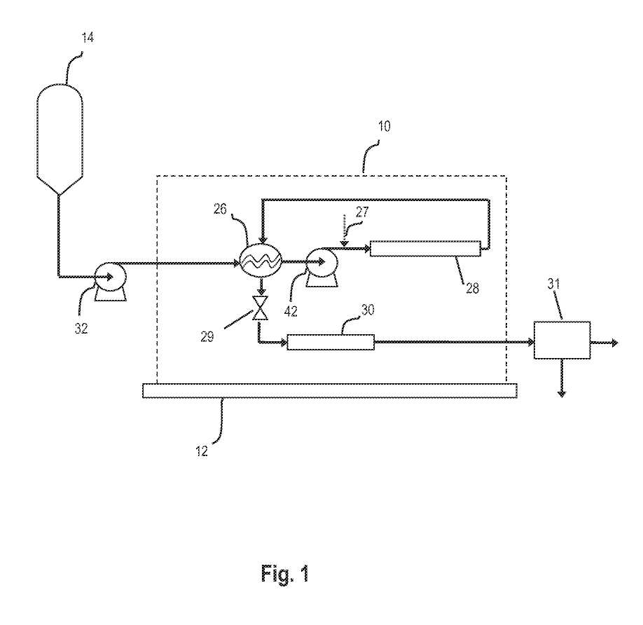

A thermal treatment system 10 is disclosed for processing an organic feedstock received from a sludge generation process, such as a wastewater biological treatment plant or a sludge digester in a wastewater treatment plant (WWTP) 14. In the mode of operation, which is shown in FIG. 1, system 10 further treats the digested material from the digester of a WWTP 14 to generate a renewable fuel product. The modes of operation are described further below.

The first mode of operation will be described with reference to FIG. 1. System 10 receives the organic feedstock from WWTP 14, which may include sewage in the form of a sludge. More specifically, the organic feedstock from WWTP 14 may include untreated sewage sludge or processed sewage sludge, such as sludge containing Class A or Class B biosolids. The term “biosolids” as used throughout this disclosure has its ordinary meaning in the art. For example, biosolids include dead organic cells, bacterial cell masses, inorganic compounds (e.g., grits, sand), cell-bound water, soil-like residue of materials removed from sewage during the wastewater treatment process, and other solids.

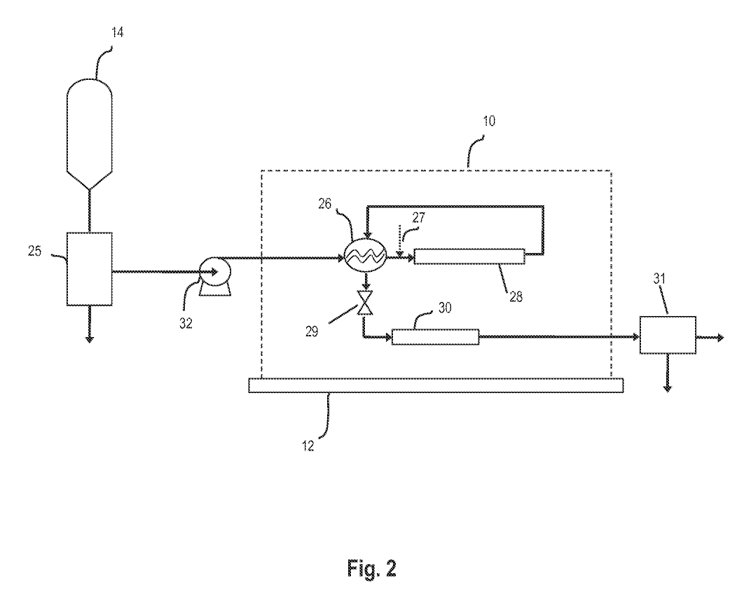

The first mode of operation will be described with reference to FIG. 2. After leaving WWTP 14, the organic feedstock may be subjected to a slurrying process in a slurrying device 25. In certain embodiments, the slurrying process may involve thinning the feedstock, such as by adding dilution water to the feedstock and/or macerating the feedstock to reduce the size of solid particles contained in the feedstock. In other embodiments, the slurrying process may involve thickening the feedstock, such as by settling, flotation, centrifuging, belt pressing, or rotary pressing. The slurrying device 25 may be outside of and separate from system 10. Additionally, the organic feedstock may be subjected to a polymer treatment process, a chemical treatment process, such as being mixed with a chelating agent, or a biological treatment process, such as being mixed with bacteria and protozoans. The moisture content of the incoming organic feedstock from WWTP 14 may be as low as approximately 10 vol. %, 70 vol. %, 75 vol. %, or 80 vol. % and as high as approximately 85 vol. %, 90 vol. %, 95 vol. %, or 97 vol. %, or within any range defined between any pair of the foregoing values, for example. The remaining volume of the organic feedstock may comprise biosolids, such as dead organic cells, bacterial cell masses, inorganic compounds (e.g., grits, sand), and other solids, as well as dissolved substances, such as ammonia (NH₃).

In addition to undigested and digested sewage sludge, the organic feedstock from WWTP 14 may include other organic materials, especially those containing cell-bound water. For example, the organic feedstock may include paper mill sludge, food waste, plant matter (e.g., rice hulls, hay straw), discarded cellulosic packaging material, bagasse, green waste (e.g., leaves, clippings, grass), algae, wood and wood waste, clinker or other residue from combustion of wood, palm oil residue, and short rotation crops. The organic feedstock may also include animal carcasses. The organic feedstock may also include agricultural waste such as sewage material obtained from the live-stock industry (e.g., hog manure, chicken litter, cow manure). The organic feedstock may also include crops grown specifically for use in the process, such as switch grass or other plants. The organic feedstock may also include municipal solid waste, fats, oils, and greases (FOG), medical waste, paper waste, refuse derived fuels, Kraft Mill black liquor, or hydrophilic non-renewable fuels (e.g., low-rank coals). In an exemplary embodiment, the organic feedstock may include a blend of biosolids and other organic materials, including biomass, to enhance the heating value of the final product and/or increase the scale of production.

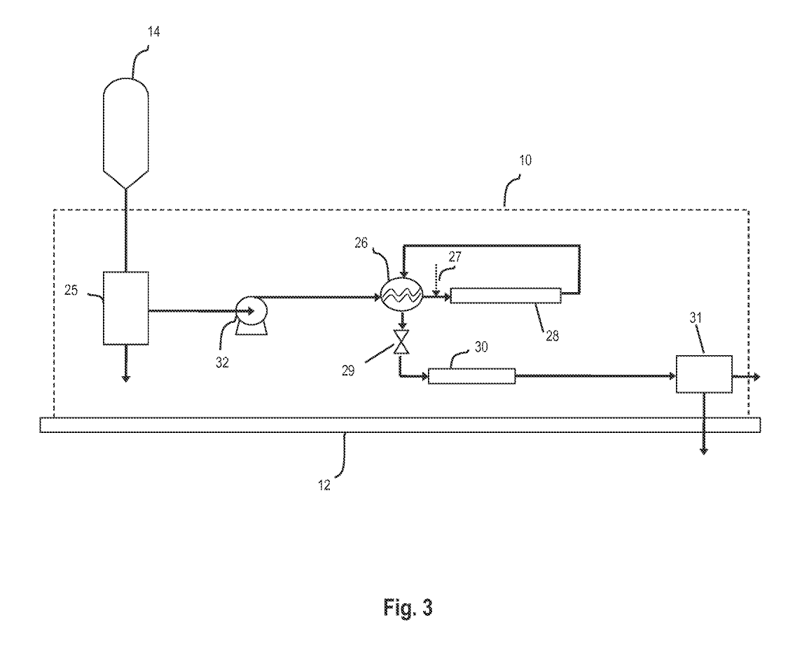

In the illustrated embodiments of FIG. 1, FIG. 2, and FIG. 3 the organic feedstock is in the form of a slurry that is pumped from WWTP 14 to a mobile system 10 using pump 32. In the illustrated embodiments of FIG. 1 and FIG. 2, the slurrying device 25 and/or pump 32 are separate from the mobile system 10. In the illustrated embodiment of FIG. 3, the pump 32 is included as a component within the mobile system 10. The components that are part of the mobile system 10 are shown coupled to a mobile support structure 12 in FIGS. 1-3, which may also be referred to herein as a skid or a platform. The mobile support structure 12 may be coupled to at least one of a trailer, truck, train, or other mode of transportation to move system 10. The mobile support structure 12 allows for transportation of the corresponding system 10 to a location where it will be placed in service, either temporarily or permanently. If the mobile support structure 12 is permanently installed, it is understood that the support structure 12 that was once mobile (e.g., during transportation of system 10) may become immobile (e.g., during use of system 10). In addition, the mobile support structure 12 allows system 10 to potentially service more than one WWTP 14 whereby great economies can be realized.

According to an exemplary embodiment of the present disclosure, the feedstock leaving the slurrying device 25 has a solids content of about 16% or less, more specifically a solids content as low as about 2, 4, 6, or 8% and as high as about 10, 12, 14, or 16%, or within any range delimited by any pair of the forgoing values. For example, the feedstock may have a solids content between about 8% and about 12%. Within this range, the feedstock may remain as a Newtonian fluid that can be pumped as a liquid with relatively low pumping energy. As a result, the corresponding pump 32 may be relatively small in size and low in cost to accommodate the mobile or skid-assembled nature of the system 10. An exemplary pump 32 is a progressive cavity pump that uses a helical rotor to force material through a set of fixed-size cavities. Such pumps are commercially available from Moyno, Inc. of Springfield, Ohio. Also, the equipment downstream of pump 32 may be designed for relatively low pressure ratings for similar size and cost savings. Above this range, the feedstock may begin to act as a Bingham Plastic whereby additional pumping energy is required to counteract the non-Newtonian fluid, which requires larger and more expensive equipment.

To prepare the organic feedstock for subsequent heating, pump 32 pressurizes the organic feedstock to a pressure above the saturation pressure of water at the subsequent elevated temperature. Pressurizing the organic feedstock maintains a liquid phase in the slurry during subsequent heating by substantially inhibiting water in the slurry from vaporizing. Depending on the subsequent elevated temperature, pump 32 may pressurize the organic feedstock to a pressure as low as approximately 1 psig, 30 psig, or 50 psig and as high as approximately 1000 psig, 1300 psig, 1500 psig, or 3200 psig, or within any range defined between any pair of the foregoing values, for example.

The pressure supplied by pump 32 may vary depending on the viscosity of the organic feedstock. As the viscosity of the organic feedstock increases, the pressure supplied by pump 32 may be increased to account for downstream pressure loss. Care must be exercised to provide pump 32 with an adequate net pump suction head (NPSH), either hydraulically or by mechanical assistance, considering that the organic feedstock may be very viscous and may carry dissolved gases. In one embodiment, the pressurized organic feedstock may travel from pump 32 along a vertical or downward-sloping plane to, with assistance from the Earth's gravitational force, reduce the demand on pump 32 and/or reduce the likelihood of gritty or sticky solid portions of the organic feedstock collecting downstream.

Next, the pressurized slurry from pump 32 continues to a first thermal input device, such as a heat exchanger 26, as shown in FIG. 1. In the heat exchanger 26, the pressurized slurry is heated first via exchange of heat with pressurized slurry exiting the reactor 28. A spiral heat exchanger 26 may conserve space on the mobile support structure 12 compared to a pipe-in-pipe heat exchanger 26. Suitable spiral heat exchangers are commercially available from Tranter, Inc. of Wichita Falls, Tex. Subsequently, the slurry is optionally heated via addition of steam at a second thermal input device, such as a steam injection nozzle 27 at a point in the system between the pressurized slurry exit from heat exchanger 26 and pressurized slurry inlet to reactor 28. It is within the scope of the present disclosure to heat the pressurized slurry in stages using more than one heat exchanger and to inject steam via one or more points of injection directly into reactor 28.

According to an exemplary embodiment of the present disclosure, a supplemental pump 42 may be provided between the first thermal input device 26 and the second thermal input device 27. The demand on the first pump 32 may be relatively low, supplying enough pressure to move the slurry through the first thermal input device 26 while maintaining the slurry in the liquid phase after initial heating in the first thermal input device 26. The demand on the supplemental pump 42 may be relatively high, supplying enough pressure to move the slurry through the second thermal input device 27 and other downstream components while maintaining the slurry in the liquid phase after further heating in the second thermal input device 27. However, the initial heating that occurs in the first thermal input device 26 may decrease the viscosity of the slurry and the corresponding demand on the supplemental pump 42, allowing the supplemental pump 42 to be relatively small in size and low in cost. An exemplary first pump 32 is an air-diaphragm pump, which may be commercially available from Wilden Pump & Engineering, LLC of Grand Terrace, Calif. An exemplary supplemental pump 42 is a progressive cavity pump, which is described further above. In certain embodiments, the initial heating and viscosity reduction that occur in the first thermal input device 26 may allow the feedstock to have a solids content of about 35% or less, more specifically a solids content as low as about 1, 3, 5, 7, 9, 11, 13, 15, 17, or 19% and as high as about 21, 23, 25, 27, 29, 31, 33, or 35%, or within any range delimited by any pair of the forgoing values.

According to an exemplary embodiment of the present disclosure, heat exchanger 26 and/or steam injection nozzle 27 heat the pressurized slurry to a temperature sufficient to cause cellular lysing, decarboxylation, and/or carbonization. In certain embodiments, cellular lysing begins at a temperature of about 230° F. (110° C.). At this lysing temperature, cellular structures (e.g., cellular walls, cellular lipid-bilayer membranes, internal cellular membranes) in the slurry begin to rupture. As a result, the cells begin to break down into particles of smaller size and release their cell-bound water. Also, the viscosity of the heated slurry may decrease substantially. Additionally, impurities (e.g., sodium, potassium, chlorine, sulfur, nitrogen, toxic metals) may separate from the ruptured cells as ions and dissolve into the liquid phase, making the impurities accessible for subsequent removal and disposal. To achieve such results, heat exchanger 26 and/or steam injection nozzle 27 may heat the pressurized slurry to a temperature as low as 230° F. (110° C.), 240° F. (116° C.), or 250° F. (121° C.) and as high as 260° F. (127° C.), 270° F. (132° C.), 280° F. (138° C.), or more, or within any range defined between any pair of the foregoing values, for example. As discussed above, the heating in heat exchanger 26 and steam injection nozzle 27 may occur in stages. For example, the heat exchanger 26 may heat the pressurized slurry to a first temperature of about 100° F. (38° C.) or more, and steam injection nozzle 27 may further heat the pressurized slurry to a second temperature of about 230° F. (110° C.) or more.

The pressurized and heated slurry from heat exchanger 26 and/or steam injection nozzle 27 is then directed to reactor 28, as shown in FIG. 1. Inside reactor 28, the heated slurry is allowed to dwell at the lysing temperature to encourage more cells to rupture, produce char, and release more cell-bound water. Depending on the desired degree of cellular lysing and char production, the residence time in reactor 28 may be as low as 1 minute, 3 minutes, or 5 minutes and as high as 7 minutes, 9 minutes, 11 minutes, or more, or within any range defined between any pair of the foregoing values, for example.

Reactor 28 receives the heated slurry continuously. Also, the heated slurry flows horizontally through reactor 28 with separate valve-controlled nozzle connections at various points along the length of the reactor to enhance the removal of sand, grit, and other materials from the slurry, which will collect in the bottom of reactor 28. Reactor 28 may accommodate addition of an alkali, a reducing gas, or another compound to facilitate downstream removal of undesirable constituents. For example, reactor 28 may accommodate the addition of carbon monoxide to facilitate downstream removal of precipitated NH₃.

If necessary to maintain the lysing temperature, reactor 28 may be insulated with a jacket that retains heat in the contents of reactor 28. It is within the scope of the present disclosure that the slurry will generate heat in reactor 28, thereby reducing or eliminating the need for additional heating of reactor 28.

The slurry that exits reactor 28, referred to herein as pre-treated slurry, contains a mixture of liquid and solid materials. The liquid phase of the pre-treated slurry includes the once-cell-bound water that was released during lysing and dissolved compounds, including dissolved carbon dioxide, dissolved NH₃, dissolved mercury, and dissolved sulfur compounds. Volatile materials, such as carbon dioxide, may be forced to remain in the liquid phase under the high pressure supplied by pump 32. However, some gases may form in the process. To prevent the evolved gases from accumulating in the piping and equipment, the evolved gases may be continuously removed from vents located throughout system 10. For example, vents may be located in reactor 28, at high points in system 10, and in confined areas, such as centrifugal pump casings, having localized pressure drops that allow dissolved gases to evolve from the liquid slurry. The solid phase of the pre-treated slurry includes primarily ruptured cellular structures and inorganic compounds (e.g., grit, sand). The solid content of the pre-treated slurry may be as low as approximately 1% wt. %, 10 wt. %, 20 wt. %, or 30 wt. %, and as high as approximately 40 wt. % or 50 wt. %, or 75 wt. %, or within any range defined between any pair of the foregoing values, for example. The solid content of the pre-treated slurry may decrease in reactor 28 due to the release of bound organics into the liquid and gaseous phases, as well as chemical reactions among the constituents.

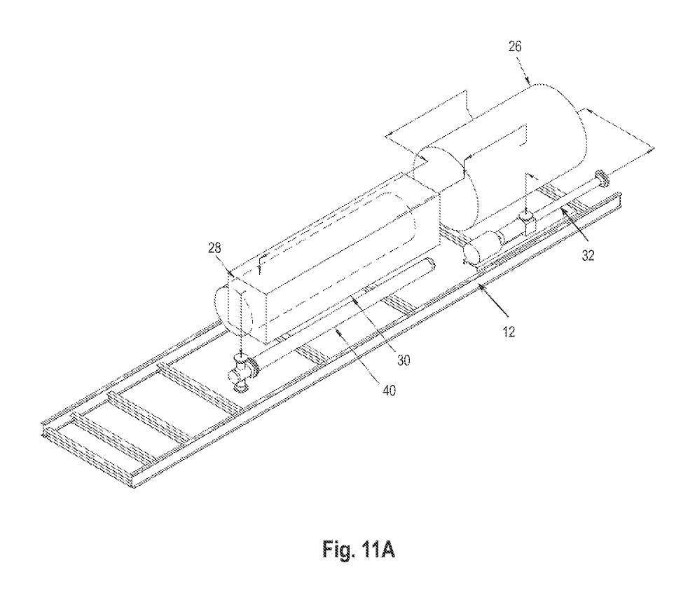

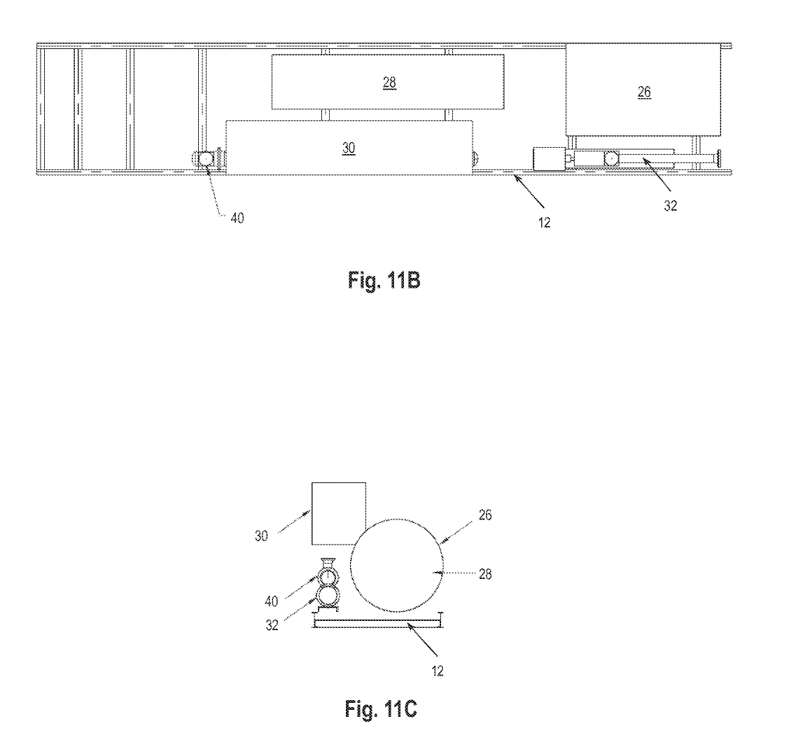

The pre-treated slurry from reactor 28 continues to heat exchanger 26, as shown in FIG. 1, or to another suitable cooler (e.g., cooler 40 of FIGS. 11A-11C). The pre-treated slurry is cooled by exchange with the cool, incoming organic feedstock. Although a single heat exchanger 26 is illustrated in FIG. 1, it is within the scope of the present disclosure to cool the pre-treated slurry in stages using more than one heat exchanger.

From heat exchanger 26, the cooled treated slurry is directed to pressure reducing valve 29 as shown in FIG. 1. Following pressure reducing valve 29, the pressure of the post-treated slurry may be reduced to atmospheric pressure, 5 psig, or 10 psig, for example. The pressure reduction liberates volatile materials once forced to remain in the liquid phase, such as carbon dioxide, hydrogen sulfide, and other non-condensable gases. The pressure reduction may also liberate some small amounts of water vapor. However, by cooling the post-treating slurry before depressurization, most of the water will remain in the liquid phase for removal during subsequent mechanical dewatering and thermal drying processes. Following pressure reducing valve 29, vents may also used to release vent gases that evolved elsewhere in system 10. For example, vent piping (not shown) may connect reactor 28 and/or the digester of a WWTP 14 to pressure letdown tank (not shown) to release gases that evolved in reactor 28 and/or the digester of a WWTP 14, along with the other gases that evolved in the pressure letdown tank.

From pressure reducing valve 29, an auxiliary heating vessel or holding tank 30 as shown in FIG. 1 is used for holding sludge at a temperature greater than or equal to the elevated temperature for additional time necessary to comply with pathogen inactivation regulations and separation of volatile materials from the cooled treated slurry. The simultaneous reduction in pressure and temperature of the cooled treated slurry described in the previous paragraph liberates volatile materials once forced to remain in the liquid phase, such as carbon dioxide, hydrogen sulfide, mercaptans, and other non-condensable gases, as well as water vapor. Because NH₃ exists in equilibrium with water in the slurry, NH₃ may also evaporate along with the water vapor. Evaporating NH₃ may make the final product more suitable for subsequent combustion and may allow the evaporated NH₃ to be recovered, such as with an ammonia scrubber, and sold. Vents are provided within auxiliary heating vessel or holding tank 30 for removal of liberated volatile materials.

The outputs from auxiliary heating vessel or holding tank 30 include a liberated vapor stream and a solid-liquid slurry stream. The liberated vapor stream exiting auxiliary heating vessel or holding tank 30 may be captured, purified, and sold, burned to destroy odors, burned for energy recovery, processed to destroy undesirable components, or otherwise processed. The solid-liquid slurry stream is directed to a mechanical dewatering device, illustratively centrifuge 31. Other suitable dewatering devices include spray dryers, filters, belt presses, and rotary presses, for example. The slurry entering centrifuge 31 includes primarily liquid materials, with solid materials making up as little as approximately 0.5 wt. %, 10 wt. %, 15 wt. %, or 20 wt. % of the slurry and as much as approximately 25 wt. %, 30 wt. %, 35 wt. %, or 90 wt. % of the slurry, or within any range defined between any pair of the foregoing values, for example. In centrifuge 31, the slurry is subjected to high speed rotation to separate the liquid materials from the solid materials. Most of the liquid materials will exit centrifuge 31 in the liquid centrate stream, and most of the solid materials will exit centrifuge 31 in the cake.

The liquid centrate stream exiting centrifuge 31 may undergo subsequent processing such as return of the liquid centrate is returned to WWTP 14 for further processing, treatment for recovery of valuable constituents, or discharged to a sewer or the environment.

The cake exiting centrifuge 31 may contain essentially equal amounts of solid and liquid materials. For example, the solid content of the cake may be as low as approximately 15 wt. %, 35 wt. %, 40 wt. %, or 45 wt. % and as high as approximately 50 wt. %, 55 wt. %, 60 wt. %, 90 wt. %, or more, or within any range defined between any pair of the foregoing values. The cake may be land-applied and used as a fertilizer without requiring further processing. Alternatively, the cake may continue to a thermal dryer to drive off more water and other volatile materials.

The thermal treatment system 10 in FIG. 1 and FIG. 2 for processing an organic feedstock received from a sludge generation process is an integrated process capable of receiving un-slurried or pre-slurried organic feedstock to produce a treated slurry suitable for subsequent dewatering. The thermal treatment system 10 in FIG. 3 is presented as a variation that includes a slurrying device 25 and/or final dewatering equipment 31 in the final integrated mobile system 10.

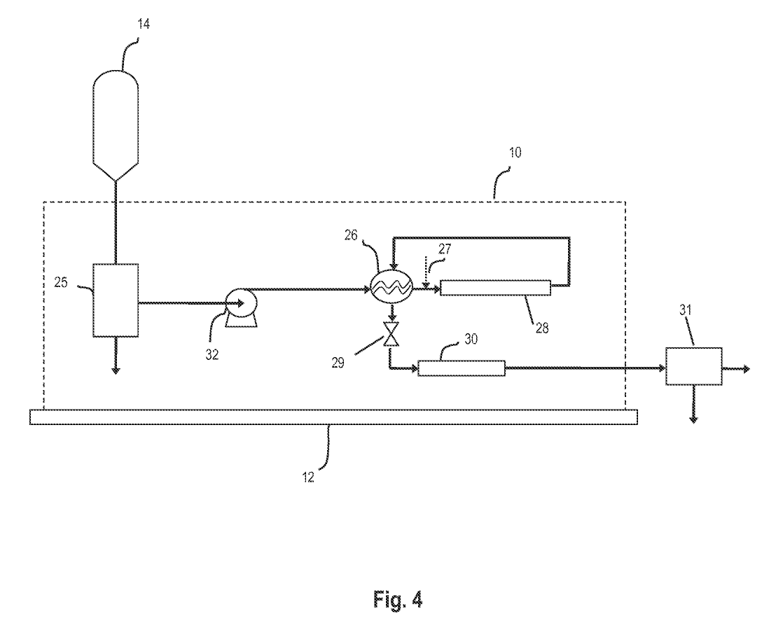

While this invention has been described as having exemplary designs, the present invention can be further modified within the spirit and scope of this disclosure. This application is therefore intended to cover any variations, uses, or adaptations of the invention using its general principles such as but not limited to the embodiments shown in FIGS. 4-10.

In FIG. 4, the sludge slurrying process that occurs in the slurrying device 25 can be integrated onto the same mobile support structure 12 as the thermal treatment process that occurs in the heat exchanger 26.

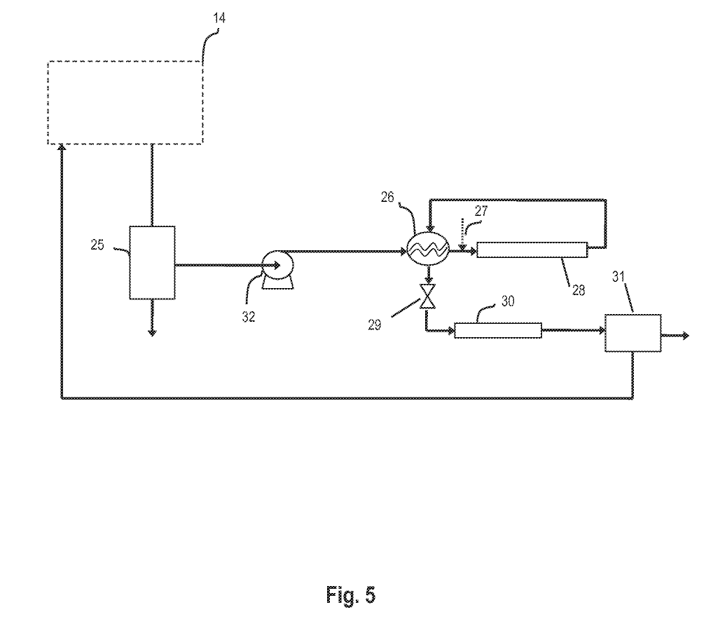

FIG. 5 includes the treatment of primary and secondary wastewater treatment sludge with recycle of the filtrate following dewatering in the dewatering device 31 directly back to the WWTP 14.

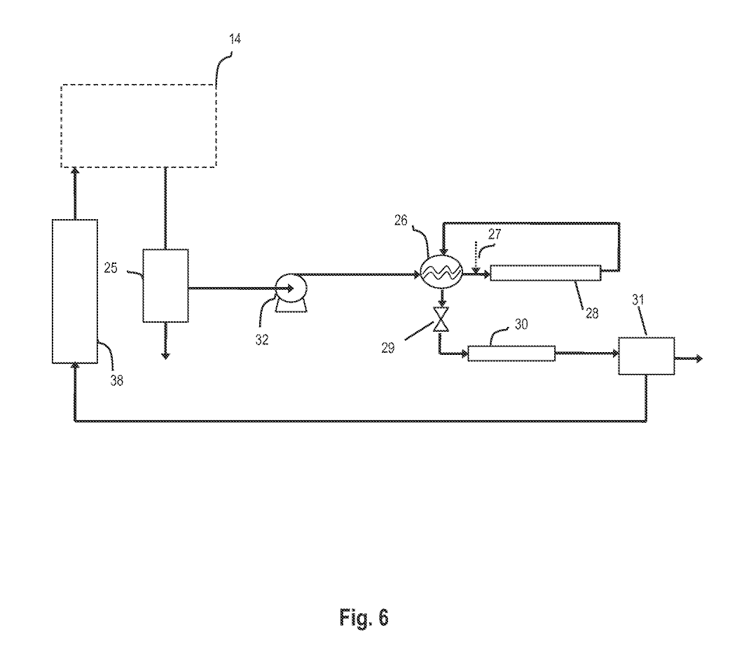

In FIG. 6, the filtrate from the centrifuge 31 is further treated with a separate aerobic or anaerobic treatment process in digester 38 before being returned to the WWTP 14.

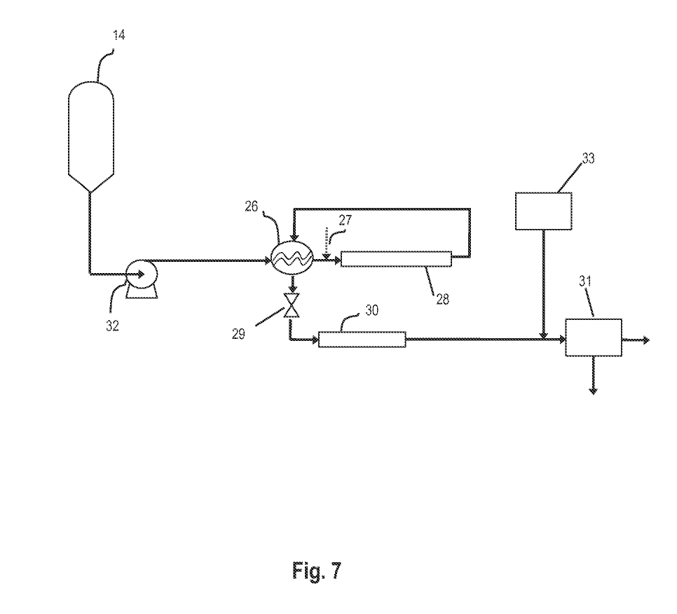

FIG. 7 includes the addition of water from a water supply 33 prior to dewatering the slurry in the dewatering device 31 to reduce the residual dissolved organic content in the final dewatered sludge cake.

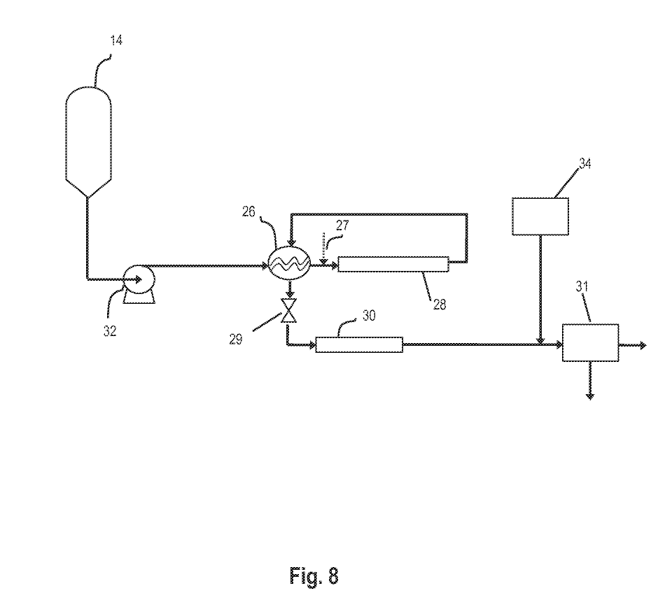

FIG. 8 includes the addition of chemicals from a chemical supply 34 prior to dewatering the slurry in the dewatering device 31 to capture ammonia and phosphate to enhance the fertilizer value via precipitation of struvite that is subsequently retained in the final dewatered sludge cake.

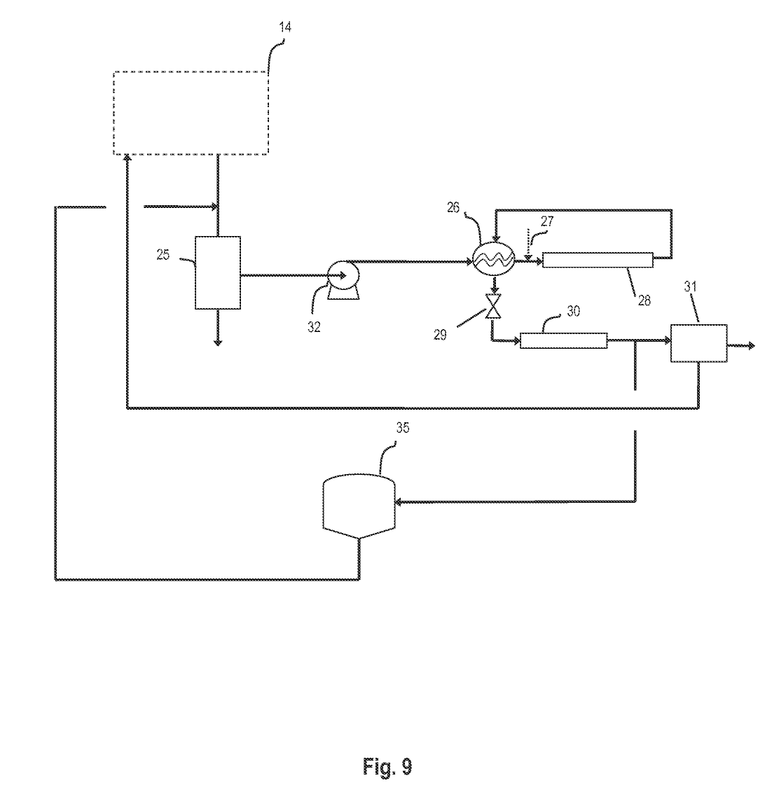

FIG. 9 processes at least a portion of the thermally treated slurry from the reactor 28 with an aerobic or anaerobic biological treatment process in a digester 35 that reduces the net amount of soluble organics by a percentage necessary to meet Vector Attraction Reduction criteria. A waste sludge from the digester 35 may be recycled to the slurrying device 25 to blend with the feedstock.

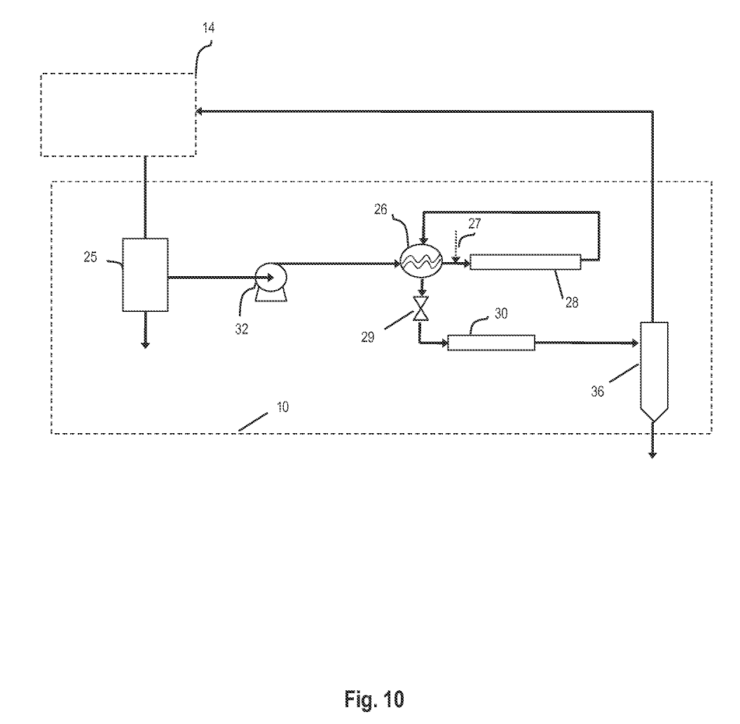

FIG. 10 includes a thermal treatment process 10 having a separation device 36 that selectively separates inert, non-reactive, and non-degradable suspended solids like grit and sand from the thermally treated, reactive, degradable, and largely carbonaceous materials like carbon, char, and other carbonaceous suspended solids that remain in the liquid stream. The separation device 36 may operate based on centrifugal force or gravity separation using differences in settling rates resulting from particle size and specific gravity differences, where the faster-settling particles represent non-degradable suspended solids and the slower-settling particles represent degradable suspended solids. The separation device 36 may direct the degradable solids to the WWTP 14 or a separate digester 35 (FIG. 9) for further biological and thermal degradation of residual reactive carbonaceous suspended solids and for conversion of said constituents into carbon-based gaseous products such as methane and carbon monoxide and additional biomass that becomes the organic material fed to the thermal treatment process 10.

Referring next to FIGS. 11A-11C, a mobile support structure, specifically a skid 12, is shown for use with the thermal treatment systems of FIGS. 1-10. Skid 12 may be coupled to at least one of a trailer, truck, train, or other mode of transportation to move skid 12 and the equipment mounted on skid 12. Skid 12 allows for transportation of the thermal treatment system to a location where it will be placed in service, either temporarily or permanently. In addition, skid 12 allows the thermal treatment system to potentially service more than one wastewater treatment plant whereby great economies can be realized. In the illustrated embodiment of FIGS. 11A-11C, skid 12 is shown supporting a pump 32, such as a progressive cavity pump, a heat exchanger 26, such as a spiral heat exchanger, a reactor 28, a holding tank 30, and a cooler 40. The size and shape of skid 12 may vary to accommodate more or less equipment. Also, the size and shape of skid 12 may vary depending on the mode of transportation used to transport skid 12. For example, the dimensions of skid 12 may be about 8 feet in width by about 8 feet in height if skid 12 is delivered via a semi-truck trailer, or about 9 feet in width by about 10 feet in height if skid 12 is delivered via a train car.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A mobile thermal treatment system for processing a feedstock including organic material and water, the system comprising:
a mobile support structure;
a slurrying device that produces a slurry from the feedstock, the slurry having a solids content of about 16% solids or less;
a pump that pressurizes the slurry to a pressure above the saturation pressure of water at a subsequent elevated temperature;
a thermal input device coupled to the mobile support structure, the thermal input device heating the pressurized slurry to the elevated temperature sufficient for cell lysing and char formation; and
a reaction device coupled to the mobile support structure, the reaction device providing a retention time to thermally treat the heated slurry at the elevated temperature.

2. The system of claim 1, further comprising an aerobic or anaerobic digester that biologically treats the thermally treated slurry from the reaction device.

3. The system of claim 2, wherein a waste sludge from the digester is recycled into the feedstock.

4. The system of claim 1, further comprising a dewatering device to remove water from the thermally treated slurry to produce a dewatered sludge cake.

5. The system of claim 4, further comprising an aerobic or anaerobic digester that biologically treats the removed water from the dewatering device.

6. The system of claim 4, further comprising a water supply to the thermally treated slurry after the reaction device and prior to the dewatering device to facilitate reduction of residual dissolved organic material within the dewatered sludge cake.

7. The system of claim 4, further comprising a chemical source to the thermally treated organic material after the reaction device and prior to the dewatering device to facilitate removal of dissolved nitrogen and phosphorus compounds from an aqueous phase of the thermally treated organic material by precipitating ammonia and phosphate as struvite or other precipitated filterable particles that are subsequently retained within the dewatered sludge cake.

8. The system of claim 4, wherein the dewatering device selectively separates the thermally treated slurry, via differences in settling rates resulting from particle size and specific gravity differences, into a first portion including faster-settling, non-degradable suspended solids present in the thermally treated slurry and a second portion including slower-settling, degradable suspended solids present in the thermally treated slurry, the dewatering device directing the second portion to a digester.

9. The system of claim 4, wherein the dewatered sludge cake is suitable for use as a fertilizer or a renewable fuel.

10. The system of claim 1, further comprising a spray dryer to dry the thermally treated slurry.

11. The system of claim 1, wherein the feedstock is diluted with water in the slurrying device.

12. The system of claim 1, wherein the feedstock comes from more than one source.

13. The system of claim 1, wherein the mobile support structure comprises a skid.

14. The system of claim 1, wherein the slurry from the slurrying device has a solids content of about 4% to about 16% solids.

15. The system of claim 14, wherein the slurry from the slurrying device has a solids content of about 8% to about 12% solids.

16. The system of claim 4, wherein at least one of the slurrying device, the pump, and the dewatering device is coupled to the mobile support structure with the thermal input device and the reaction device.

17. The system of claim 1, further comprising a holding tank downstream of the reaction device, the holding tank providing additional time to further treat the thermally treated slurry at a temperature greater than or equal to the elevated temperature.

18. A mobile thermal treatment system for processing a feedstock including organic material and water, the system comprising:
a mobile support structure;
a slurrying device that produces a slurry from the feedstock;
a first pump that pressurizes the slurry to a first pressure above the saturation pressure of water at a first elevated temperature;
a first thermal input device coupled to the mobile support structure downstream of the first pump, the first thermal input device heating the pressurized slurry to the first elevated temperature;
a second pump coupled to the mobile structure downstream of the first thermal input device, the second pump further pressurizing the heated slurry to a second pressure above the saturation pressure of water at a second elevated temperature;
a second thermal input device coupled to the mobile support structure downstream of the second pump, the second thermal input device further heating the pressurized slurry to the second elevated temperature sufficient for cell lysing and char formation; and
a reaction device coupled to the mobile support structure, the reaction device providing a retention time to thermally treat the heated slurry at the second elevated temperature.

19. The system of claim 18, wherein the slurry from the slurrying device has a solids content of about 35% solids or less.

20. The system of claim 18, wherein the first pump is an air-diaphragm pump.

21. The system of claim 18, wherein the second pump is a progressive cavity pump.

22. The system of claim 18, further comprising a dewatering device to remove water from the thermally treated slurry to produce a dewatered sludge cake.
